(19) United States
(12) Patent Application Publication
(10) Pub. No.: US 2025/0260983 A1
(43) Pub. Date: Aug. 14, 2025

(54) Method and System for Unlocking a Mobile Device, Mobile Device, and Computer Program Product

(71) Applicant: Andreas Stihl AG & Co. KG, Waiblingen (DE)

(72) Inventors: Patrick LEVIEN, Freudenberg (DE); Kerstin WEISS, Murrhardt (DE); Sebastian LEHMANN, Weinstadt (DE); Hyun-Young KIM, Stuttgart (DE); Simon TRINKLE, Kaisersbach (DE)

(21) Appl. No.: 19/047,711

(22) Filed: Feb. 7, 2025

(30) Foreign Application Priority Data
Feb. 8, 2024 (DE) 10 2024 103 499.8

(51) Int. Cl. H04W 12/082; H04W 12/30; H04W 12/61; H04W 12/64

(52) U.S. Cl. CPC H04W 12/082; H04W 12/30; H04W 12/61; H04W 12/64

(57) ABSTRACT

A method unlocks a mobile device in the form of a motor-driven user-controlled handheld gardening, forestry, construction, and/or cultivating device and/or a battery pack for such a device, for a limited unlocked period of time, unlocked operating period of time, unlocked number of operating cycles, and/or unlocked amount of operating energy for an operation of the device outside a bounded position area. The method includes: detecting the device inside the bounded position area, and triggering, when the device is detected inside the position area, the unlocking of the device for the limited unlocked period of time, unlocked period of operating time, unlocked number of operating cycles, and/or unlocked amount of operating energy, for the operation of the device outside the bounded position area.

### CROSS REFERENCE TO RELATED APPLICATION

This application claims priority under 35 U.S.C. § 119 from German Patent Application No. 10 2024 103499.8, filed Feb. 8, 2024, the entire disclosure of which is herein expressly incorporated by reference.

### BACKGROUND AND SUMMARY

The invention relates to a method and a system, in particular respectively, for unlocking a mobile device, a mobile device for such a method and/or such a system, and a computer program product having commands for unlocking such a mobile device.

The invention is based on the object of providing a method and a system, in particular respectively, for unlocking a mobile device, a mobile device for such a method and/or such a system, and a computer program product having commands for unlocking such a mobile device, which have/has improved properties.

The invention achieves this object by providing a method, a system, a mobile device, and a computer program product described in the independent claims. Advantageous refinements and/or embodiments of the invention are described in the dependent claims.

The method according to the invention is for unlocking a mobile device in the form of a motor-driven user-controlled, in particular manually-controlled, in particular handheld gardening, forestry, construction, and/or cultivating device and/or a battery pack for the gardening, forestry, construction, and/or cultivating device, for a limited unlocked period of time, unlocked operating period of time, unlocked number of operating cycles and/or unlocked amount of operating energy and/or unlocked ending period of time for an operation of the device outside at least, in particular precisely, one bounded position area. The method comprises the following steps:
a) detecting the device inside the bounded position area; and
b) triggering, at least when, in particular precisely, thus or in the case that, the device is detected inside the position area, an unlocking of the device for the limited unlocked period of time, unlocked operating period of time, unlocked number of operating cycles and/or unlocked amount of operating energy and/or unlocked ending period of time for operation of the device outside the bounded position area.

This enables a protection against operation which is undesired, in particular by an owner and/or a manager of the device, in particular undesired theft, of the device outside the position area. Additionally or alternatively, this enables simple, in particular desired and/or intended, operation of the device outside the position area unlocked by bringing and/or providing the device inside the position area, in particular by a user of the device.

In particular, the method, the unlocking, and/or the detecting can be automatic and/or computer-implemented.

The detecting or step a) can be performed by means of a detecting device.

The unlocking or step b) can be performed by means of an unlocking device.

The term “unit” can be used synonymously for the term “device”.

The term “carried out” or the wording “are carried out” or “are implemented” can be used synonymously for the wording “are performed”.

The mobile device can have a mass of at most 50 kg (kilograms), in particular at most 20 kg, in particular at most 10 kg, in particular at most 5 kg, and/or at least 0.2 kg, in particular at least 0.5 kg, in particular at least one kilogram, in particular at least 2 kg.

The term “portable” can be used synonymously for the term “mobile”.

The gardening, forestry, construction, and/or cultivating device can be ground-based and/or operable or controllable manually or by the user and/or electrically driven, in particular using operating energy from the battery pack.

The gardening, forestry, construction, and/or cultivating device and the battery pack can be designed for an electrical, and in particular mechanical and/or tool-free and/or, in particular nondestructive, user-releasable connection to one another, in particular can comprise the connection and/or for operation.

The battery pack can be rechargeable and/or can be designed for supplying the gardening, forestry, construction, and/or cultivating device with operating energy, in particular electrical operating energy, in particular upon the connection.

The term “rechargeable battery pack” can be used synonymously for the term “battery pack”.

The operation or an operation of the device can be a motor operation or an operation of a drive motor and/or an energy or power operation and/or a discharging operation and/or a use or an employment and/or processing by means of the gardening, forestry, construction, and/or cultivating device.

The unlocked period of time, unlocked operating period of time, unlocked number of operating cycles and/or unlocked amount of operating energy and/or unlocked ending period of time can have a value, in particular corresponding to, in particular equal to at least 1 day, in particular at least 1 week, and/or at most 2 months, in particular at most 1 month, and/or be specified, in particular at the factory and/or by the owner and/or the manager.

The position area can be a residence, a warehouse, and/or a means of transport, in particular a vehicle, of the device and/or can be specified, in particular by the owner and/or the manager, and/or can or does not have to be an arbitrary radio cell.

The term “predetermined”, “preset”, “defined”, “selected”, “stored”, or “saved” can be used synonymously for the term “specified”.

The term “location” can be used synonymously for the term “position”.

The term “detect” or the wording “establishing a presence” can be used synonymously for the term “detecting”.

In the case that the device is not detected inside the position area, the device can be outside the position area and/or the unlocking or step a) can or does not have to be performed.

The term “outside” can be used synonymously for the wording “not inside”.

The term “enable” can be used synonymously for the term “unlock”.

The unlocking or an unlocking of the device can be updated or refreshed or renewed.

Step a) can be performed repeatedly and/or continuously or progressively, in particular multiple times.

Step b) can be performed chronologically, in particular immediately or directly, after step a) and/or can be performed repeatedly and/or continuously or progressively, in particular multiple times.

The method can be performed repeatedly and/or continuously or progressively, in particular multiple times.

Moreover, reference is made to the technical literature.

In a refinement of the invention, step a) or the detecting of the device inside the position area comprises: determining a position of the device, in particular by means of the device and/or a global positioning system, in particular a global navigation satellite system, and checking that the determined position is inside the position area. This enables simple detecting of the device inside the position area, simple unlocking of the device, and/or simple operation of the device outside the position area. In particular, the determination and/or the checking can be automatic and/or computer-implemented. Additionally or alternatively, the determination can be performed by means of a positioning device of the device, which is electrical in particular. Furthermore, additionally or alternatively, the global navigation satellite system can be NAVSTAR GPS, GLONASS, Galileo, and/or BeiDou. Furthermore, additionally or alternatively, the position and/or the position area can comprise a value and/or coordinates. Furthermore, additionally or alternatively, in the case that the position is inside the position area, in particular checked, the device can be detected inside the position area. Furthermore, additionally or alternatively, in the case that the position is outside the position area, in particular checked, the device may not be detected inside the position area. Furthermore, additionally or alternatively, the checking can comprise a comparison of the position to the position area. Furthermore, additionally or alternatively, the checking can be performed by means of a control unit, which is electrical in particular, in particular of the device. Furthermore, additionally or alternatively, the term “testing” can be used synonymously for the term “checking”.

In a refinement of the invention, the method comprises, chronologically before step a), in particular initially, the following step: receiving, in particular wirelessly receiving and/or transmitting, at least one position area dimension representative of the position area by means of the or by the device, in particular from a first computing unit. Additionally or alternatively determining a specified position of the device and receiving, in particular wirelessly receiving, a confirmation signal to confirm the determined specification position to specify the position area by means of the or by the device, in particular from a, in particular the first computing unit. This enables a simple, in particular one-time, specification or learning or training of the position area. In particular, the receiving, the determining, the confirming, and/or the specifying can be automatic and/or computer-implemented. Additionally or alternatively, the receiving can be performed by means of a receiving unit, which is in particular electrical, of the device. Furthermore, additionally or alternatively, the term “wireless” can be used synonymously for the term “wirelessly”. Furthermore, additionally or alternatively, the term “characteristic” can be used synonymously for the term “representative”. Furthermore, additionally or alternatively, the position area dimension can be the position area. Furthermore, additionally or alternatively, the position area dimension, the position area, and/or the position can comprise a value and/or coordinates. Furthermore, additionally or alternatively, the determining can be performed by means of the position determining unit. Furthermore, additionally or alternatively, the position area can be specified around the specified position. Furthermore, additionally or alternatively, the confirmation signal can comprise a value and/or a content. Furthermore, additionally or alternatively, the computing unit can be different or separate and/or authorized from the device and/or can be a managing unit and/or can be electrical.

In a refinement of the invention, the method comprises, chronologically before step b) and in particular before step a), and/or initially, the following step: receiving, in particular wirelessly receiving and/or transmitting, an unlocking variable representative of the unlocked period of time, unlocked operating period of time, unlocked number of operating cycles and/or unlocked amount of operating energy and/or unlocked ending period of time for the operation of the device by means of the or by the device, in particular from a, in particular the, first computing unit. This enables simple specification of the unlocked period of time, unlocked operating period of time, unlocked number of operating cycles and/or unlocked amount of operating energy and/or unlocked ending period of time. In particular, the receiving can be automatic and/or computer-implemented. Additionally or alternatively, the receiving can be performed by means of the receiving unit. Furthermore, additionally or alternatively, the unlocking variable can comprise a value and/or a content. Furthermore, additionally or alternatively, the unlocking variable can be the unlocked period of time, unlocked operating period of time, unlocked number of operating cycles and/or unlocked amount of operating energy and/or unlocked ending period of time.

In a refinement of the invention, step a) and/or step b) is/are performed by means of the device. This allows this step/these steps to be performed by means of precisely one device and/or particularly simply, in particular in this way.

In particular, an extension of the position area can be adjustable, in particular by the owner and/or the manager.

In a refinement of the invention, an extension of the position area is at least 2 m (meters), in particular at least 4 m, in particular at least 10 m, and/or at most 200 m, in particular at most 100 m, in particular at most 50 m, in particular 20 m. This enables particularly good protection against undesired operation outside the position area and/or particularly simple bringing of the device inside the position area. In particular, the extension can be in various directions. Additionally or alternatively, the term “diameter” can be used synonymously for the term “extension”.

In a refinement of the invention, the position area is bounded by a range of a connection that can be established, in particular a minimum strength of a signal for establishing the connection, for the wireless reception, in particular transmitting, between the device and a transmitting unit which is assigned, in particular logically. Step a) comprises: detecting the device inside the position area at least, in particular precisely, by establishing the connection, in particular the minimum strength and evaluating a strength of the signal for establishing the connection for reaching the minimum strength. This enables simple specification of the position area and/or simple detection of the device inside the position area. In particular, the range and/or the minimum strength can comprise a value. Additionally or alternatively, the term “radius” can be used synonymously for the term “range”. Furthermore, additionally or alternatively, the range, in particular at most, can correspond, in particular be equal to, half the extension of the position area. Furthermore, additionally or alternatively, the receiving, the establishing, and/or the evaluating can be automatic and/or computer-implemented. Furthermore, additionally or alternatively, the receiving, the establishing, and/or the evaluating can be performed by means of the receiving unit and/or the transmitting unit. Furthermore, additionally or alternatively, the term “associated” can be used synonymously for the term “assigned”. Furthermore, additionally or alternatively, the transmitting unit can be different or separate from the device and/or authorized and/or can be a part of the means of transport or mobile or immobile and/or electrical. Furthermore, additionally or alternatively, in the case that the connection is established, in particular the minimum strength is reached, the device can be detected inside the position area. Furthermore, additionally or alternatively, in the case that the connection is not established, in particular the minimum strength is not reached, the device may not be detected inside the position area. Furthermore, additionally or alternatively, step a) can comprise: establishing the connection. Furthermore, additionally or alternatively, the term “producing” can be used synonymously for the term “establishing”. Furthermore, additionally or alternatively, the term “analyzing” can be used synonymously for the term “evaluating”.

In one embodiment of the invention, step a), in particular establishing the connection, comprises: sending, in particular transmitting, a device identifier from the device and/or a unit identifier from the transmitting unit and checking based on the sent device identifier and/or the sent unit identifier that the device and the transmitting unit are assigned to one another. This enables secure establishing of the connection and therefore secure detecting of the device inside the position area. In particular, the sending and/or the checking can be automatic and/or computer-implemented. Additionally or alternatively, the sending of the device identifier can be performed by means of a transmitting unit, which is electrical in particular, of the device. Furthermore, additionally or alternatively, the sending of the unit identifier can be performed by means of the transmitting unit. Furthermore, additionally or alternatively, the device identifier and/or the unit identifier can comprise a value and/or a content and/or can be a serial number and/or a MAC address and/or can be unique. Furthermore, additionally or alternatively, the unit identifier can be different from the device identifier. Furthermore, additionally or alternatively, the checking of the sent unit identifier can be performed by means of the checking unit of the device. In particular, the unit identifier can be stored, in particular can become stored, chronologically before step a), in particular initially, in the device. Furthermore, additionally or alternatively, the checking of the sent device identifier can be performed by means of the transmitting unit and/or the first computing unit. In particular, the device identifier can be stored, in particular can become stored, chronologically before step a), in particular initially, in the transmitting unit and/or the first computing unit. Furthermore, additionally or alternatively, the checking can comprise comparing the sent identifier to the stored identifier. Furthermore, additionally or alternatively, in the case that the device and the transmitting unit are assigned to one another, in particular are checked, the connection can be established. Furthermore, additionally or alternatively, in the case that the device and the transmitting unit are not assigned to one another, in particular checked, the connection may not be established. Moreover, reference is made to the technical literature.

In one embodiment of the invention, step b) comprises: sending, in particular transmitting, an unlocking signal to unlock the device for the limited unlocked period of time, unlocked operating period of time, unlocked number of operating cycles and/or unlocked amount of operating energy and/or unlocked ending period of time for the operation of the device, in particular a, in particular the unlocking dimension representative for the unlocked period of time, unlocked operating period of time, unlocked number of operating cycles and/or unlocked amount of operating energy and/or unlocked ending period of time for the operation of the device, to the device from the transmitting unit through the connection. This enables simple unlocking of the device and/or simple specification of the unlocked period of time, unlocked operating period of time, unlocked number of operating cycles and/or unlocked amount of operating energy and/or unlocked ending period of time. In particular, the sending can be automatic and/or computer-implemented and/or can be performed by means of the transmitting unit. Additionally or alternatively, the unlocking signal can comprise a value and/or a content.

In one embodiment of the invention, the sending and/or the receiving, in particular the transmitting, is/are based on a short-range transmitting technology. In particular, the transmitting technology has a maximum range of 10 m and/or is Bluetooth transmitting technology and/or ZigBee transmitting technology and/or wireless local area network transmitting technology. Additionally or alternatively, the transmitting unit is a gateway and/or a router. This enables particularly good protection against undesired operation outside the position area and/or particularly simple bringing of the device inside the position area. Moreover, reference is made to the technical literature.

In one refinement of the invention, triggered at least, in particular precisely, by the unlocking of the device for the limited unlocked period of time, unlocked operating period of time, unlocked number of operating cycles and/or unlocked amount of operating energy and/or unlocked ending period of time, the unlocked period of time, unlocked operating period of time, unlocked number of operating cycles and/or unlocked amount of operating energy and/or unlocked ending period of time counts down, in particular outside the position area and/or triggered at least, in particular precisely, in that the unlocked period of time, unlocked operating period of time, unlocked number of operating cycles and/or unlocked amount of operating energy and/or unlocked ending period of time has expired, the operation of the device is blocked, in particular by means of the device. This enables the device to become, in particular be useless for a thief. In particular, the counting down and/or the blocking can be automatic and/or computer-implemented. Additionally or alternatively, the counting down can be performed chronologically immediately or directly after the unlocking, in particular also inside the position area, in particular not in the case of a repeated unlocking chronologically after the unlocking. Furthermore, additionally or alternatively, the blocking can be performed chronologically immediately or directly after the counting down. Furthermore, additionally or alternatively, the counting down can be repeatedly reduced by a defined value or amount with a defined frequency. Furthermore, additionally or alternatively, the device can comprise a counter (RTC) for the counting down, in particular a real-time counter, in particular a real-time clock. Moreover, reference is made to the technical literature.

In one embodiment of the invention, the method, in particular step b), comprises: determining and/or unlocking the unlocked period of time and/or blocking the operation of the device such that the operation of the device outside a defined working or operating time window is blocked for a use of the gardening, forestry, construction, and/or cultivating device and/or the battery pack. This makes it possible that an intended and/or deliberate operation of the device outside the position area is not supposed to be ended or blocked inside the working time window, in particular successfully. In particular, the working time window can be, in particular can become, defined by the owner and/or the manager. Additionally or alternatively, a local time zone of the device can be taken into consideration for the blocking outside the working time window.

In one refinement of the invention, the method comprises: outputting, in particular optically outputting, user-perceptible information about whether or not the operation of the device is unlocked for the unlocked period of time, unlocked operating period of time, unlocked number of operating cycles and/or unlocked amount of operating energy and/or unlocked ending period of time, in particular whether or not the unlocked period of time, unlocked operating period of time, unlocked number of operating cycles and/or unlocked amount of operating energy and/or unlocked ending period of time is counting down. This enables a perception or a recognition of a possible thief that stealing the device does not pay, and therefore deterrence from a theft, and/or handling of the device for a user. In particular, the output can be automatic and/or computer-implemented and/or can be a display and/or can be performed by means of an LED and/or the device. Additionally or alternatively, the information can comprise a value and/or a content.

In a refinement of the invention, the gardening, forestry, building, and/or cultivating device is a saw, a pole pruner, a hedge trimmer, a hedge cutter, a miniature chainsaw, a branch trimmer, a blower, a leaf blower, a suction device, a leaf vacuum, a cleaning device, a high-pressure cleaner, a jet and/or spraying device, a sweeping device, a sweeping roller, a sweeping brush, a lawnmower, a grass trimmer, a scarifier, a brush cutter, an angle grinder, or a concrete chainsaw, or a combination device made up of several of the above-mentioned gardening, forestry, construction, and/or cultivating devices. The method is particularly advantageous for such a gardening, forestry, construction, and/or cultivating device.

Additionally or alternatively, the device could be in the form of an accessory for the gardening, forestry, construction, and/or cultivating device, such as personal protective equipment, such as a hearing protector.

The system according to the invention is for unlocking the mobile device in the form of the motor-driven user-controlled, in particular manually-controlled, in particular handheld gardening, forestry, construction and/or cultivating device and/or the battery pack for the gardening, forestry, construction, and/or cultivating device for the limited unlocked period of time, unlocked operating period of time, unlocked number of operating cycles and/or unlocked amount of operating energy and/or unlocked ending period of time for the operation of the device outside the bounded position area. The system comprises the detecting unit and the unlocking unit, and in particular the device. The detecting unit is designed for detecting the device inside the bounded position area. The unlocking unit is triggered in that the device is detected inside the position area, designed to unlock the device for the limited unlocked period of time, unlocked operating period of time, unlocked number of operating cycles and/or unlocked amount of operating energy and/or unlocked ending period of time for the operation of the device outside the bounded position area. In particular, the device comprises the detecting unit and/or the unlocking unit. The system can then enable the same advantage(s) as mentioned above for the method. In particular, the system can be designed to, in particular automatically, perform the method as mentioned above. Additionally or alternatively, the term “configured”, “set up”, or “provided” or the English wording “programmed to perform the function(s) of” can be used synonymously for the term “designed”. Furthermore, additionally or alternatively, the system, the detecting unit, and/or the unlocking unit can be electric and/or can comprise a computing unit and/or a processor and/or a microcontroller and/or a storage unit and/or a computer. Furthermore, additionally or alternatively, the system, the detecting unit, and/or the unlocking unit can comprise the first computing unit and/or the transmitting unit and/or the first computing unit and/or the transmitting unit can comprise the detecting unit and/or the unlocking unit.

In other words: the system can comprise means comprising a, in particular the first computing unit, in particular the detecting unit, for detecting the mobile device in the form of the motor-driven user-controlled, in particular manually-controlled, in particular handheld gardening, forestry, construction, and/or cultivating device and/or the battery pack for the gardening, forestry, construction, and/or cultivating device inside the bounded position area and means, in particular the unlocking unit, for sending commands to a second computing unit, in particular triggered in that the device is detected inside the position area, and the second computing unit comprising means, in particular the unlocking unit, for receiving commands from the first computing unit, wherein the commands can be intended for unlocking the device by means of the second computing unit for the limited unlocked period of time, unlocked operating period of time, unlocked number of operating cycles and/or unlocked amount of operating energy and/or unlocked ending period of time for the operation of the device outside the bounded position area, in particular triggered in that the device is detected inside the position area. In particular, the system can comprise the device. Additionally or alternatively, the second computing unit can be a part of the device and/or can be electric.

Additionally or alternatively, the first computing unit can be a part of the device.

The mobile device according to the invention in the form of the motor-driven user-controlled, in particular manually-controlled, in particular handheld gardening, forestry, construction and/or cultivating device and/or the battery pack for the gardening, forestry, construction, and/or cultivating device is for the method as mentioned above and/or the system as mentioned above for unlocking the device for the limited unlocked period of time, unlocked operating period of time, unlocked number of operating cycles, and/or unlocked amount of operating energy and/or unlocked ending period of time for the operation of the device outside the bounded position area. The device comprises the detecting unit and the unlocking unit. The detecting unit is designed for detecting the device inside the bounded position area. The unlocking unit is triggered in that, the device is detected inside the position area, designed to unlock the device for the limited unlocked period of time, unlocked operating period of time, unlocked number of operating cycles and/or unlocked amount of operating energy and/or unlocked ending period of time for the operation of the device outside the bounded position area. The device can enable the same advantage(s) as mentioned above for the method. In particular, the device can be designed to perform the method, in particular automatically, as mentioned above. Furthermore, additionally or alternatively, the device can be designed as mentioned above for the method.

In other words: the mobile device in the form of the motor-driven user-controlled, in particular manually-controlled, in particular handheld gardening, forestry, construction, and/or cultivating device and/or the battery pack for the gardening, forestry, construction, and/or cultivating device can comprise at least the second computing unit for unlocking the device for the limited unlocked period of time, unlocked operating period of time, unlocked number of operating cycles and/or unlocked amount of operating energy and/or unlocked ending period of time for the operation of the device outside the bounded position area, wherein the second computing unit can receive the commands from the first computing unit, in particular triggered in that the device is detected inside the position area. In particular, the device can comprise the first computing unit.

The first computing unit according to the invention can comprise the means for detecting the mobile device in the form of the motor-driven user-controlled, in particular manually-controlled, in particular handheld gardening, forestry, construction, and/or cultivating device and/or the battery pack for the gardening, forestry, construction, and/or cultivating device inside the bounded position area and the means for sending commands to the second computing unit, wherein the first computing unit, triggered in that the device is detected inside the position area, in particular can generate the commands to unlock the device and send them to the second computing unit, wherein the unlocking by means of the second computing unit can be provided for the limited unlocked period of time, unlocked operating period of time, unlocked number of operating cycles and/or unlocked amount of operating energy and/or unlocked ending period of time for the operation of the device outside the bounded position area.

The second computing unit according to the invention can comprise the means for receiving the commands from the first computing unit, wherein the commands can be generated for unlocking the mobile device in the form of the motor-driven user-controlled, in particular manually-controlled, in particular handheld gardening, forestry, construction, and/or cultivating device and/or the battery pack for the gardening, forestry, construction, and/or cultivating device, and the means for performing the commands, which can unlock the device inside the bounded position area for the limited unlocked period of time, unlocked operating period of time, unlocked number of operating cycles and/or unlocked amount of operating energy and/or unlocked ending period of time for the operation of the device outside the bounded position area.

The computer program product according to the invention comprises the commands for unlocking the mobile device in the form of the motor-driven user-controlled, in particular manually-controlled, in particular handheld gardening, forestry, construction, and/or cultivating device and/or the battery pack for the gardening, forestry, construction, and/or cultivating device for the limited unlocked period of time, unlocked operating period of time, unlocked number of operating cycles, and/or unlocked amount of operating energy and/or unlocked ending period of time for the operation of the device outside the bounded position area. The commands comprise:
upon execution, in particular by means of the detecting unit, detecting the device inside the bounded position area.
upon execution, in particular by means of the unlocking unit, triggered in that the device is detected inside the position area unlocking the device for the limited unlocked period of time, unlocked operating period of time, unlocked number of operating cycles and/or unlocked amount of operating energy and/or unlocked ending period of time for the operation of the device outside the bounded position area.

The computer program product can enable the same advantage(s) as mentioned above for the method. In particular, the computer program product can be designed to perform the method, in particular automatically, as mentioned above and/or by means of the system as mentioned above and/or by means of the device as mentioned above. Additionally or alternatively, the computer program product can be stored on a computer-readable (storage) medium. Furthermore, additionally or alternatively, the term “instructions” can be used synonymously for the term “commands”. Furthermore, additionally or alternatively, the commands can describe the method.

In other words: The computer program product can comprise the commands for unlocking the mobile device in the form of the motor-driven user-controlled, in particular manually-controlled, in particular handheld gardening, forestry, construction, and/or cultivating device and/or the battery pack for the gardening, forestry, construction, and/or cultivating device for the limited unlocked period of time, unlocked operating period of time, unlocked number of operating cycles and/or unlocked amount of operating energy and/or unlocked ending period of time for the operation of the device outside the bounded position area, wherein the commands
upon execution or upon execution by means of the or by the first computing unit, can comprise detecting the device inside the bounded position area, and
wherein the first computing unit, triggered in that the device is detected inside the position area, can in particular generate the commands for the unlocking by means of the or by the second computing unit for the limited unlocked period of time, unlocked operating period of time, unlocked number of operating cycles and/or unlocked amount of operating energy and/or unlocked ending period of time for the operation of the device outside the bounded position area, and can send them to the second computing unit.

In particular, the commands, upon the execution or upon execution by means of the or by the second computing unit, can unlock the device for the limited unlocked period of time, unlocked operating period of time, unlocked number of operating cycles and/or unlocked amount of operating energy and/or unlocked ending period of time for the operation outside the bounded position area.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a system according to an embodiment of the invention comprising a mobile device when performing a method of a computer program product;

FIG. 2 is a further schematic view of the system comprising the device when performing the method of the computer program product;

FIG. 3 is a schematic view of the system comprising the device when performing the method of FIG. 2;

FIG. 4 is a schematic view of the device unlocked when counting down an unlocked period of time, an unlocked operating period of time, an unlocked number of operating cycles, and/or an unlocked amount of operating energy for operation of the device;

FIG. 5 is a schematic view of the device when blocked;

FIG. 6 is a further schematic view of the system when performing the method of FIG. 2 when determining and/or unlocking the unlocked period of time and/or blocking the operation of the device such that the operation of the device outside a defined working time window is blocked for a use of the device; and

FIG. 7 is a still further schematic view of the system comprising the device when performing the method of the computer program product.

### DETAILED DESCRIPTION OF THE DRAWINGS

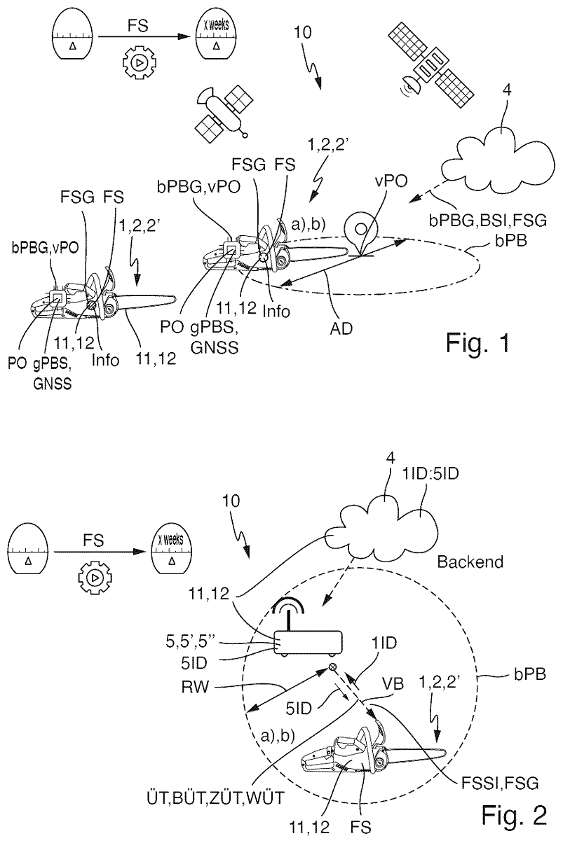

FIGS. 1 to 7 show a method of a computer program product and a system 10 according to an embodiment of the invention for unlocking a mobile device 1 in the form of a motor-driven user-controlled, in particular manually-controlled, in particular handheld gardening, forestry, construction, and/or cultivating device 2 and/or a battery pack 3 for the gardening, forestry, construction, and/or cultivating device 2 for a limited unlocked period of time, unlocked operating period of time, unlocked number of operating cycles, and/or unlocked amount of operating energy FS for operation of the device 1 outside a bounded position area bPB.

The method comprises the following steps:
a) detecting the device 1 inside the bounded position area bPB;
b) triggering, when the device 1 is detected inside the position area bPB, an unlocking of the device 1 for a limited unlocked period of time, unlocked operating period of time, unlocked number of operating cycles, and/or unlocked amount of operating energy FS, for operation of the device 1 outside the bounded position area bPB.

The system 10 comprises a detecting unit 11 and an unlocking unit 12, and in particular the device 1.

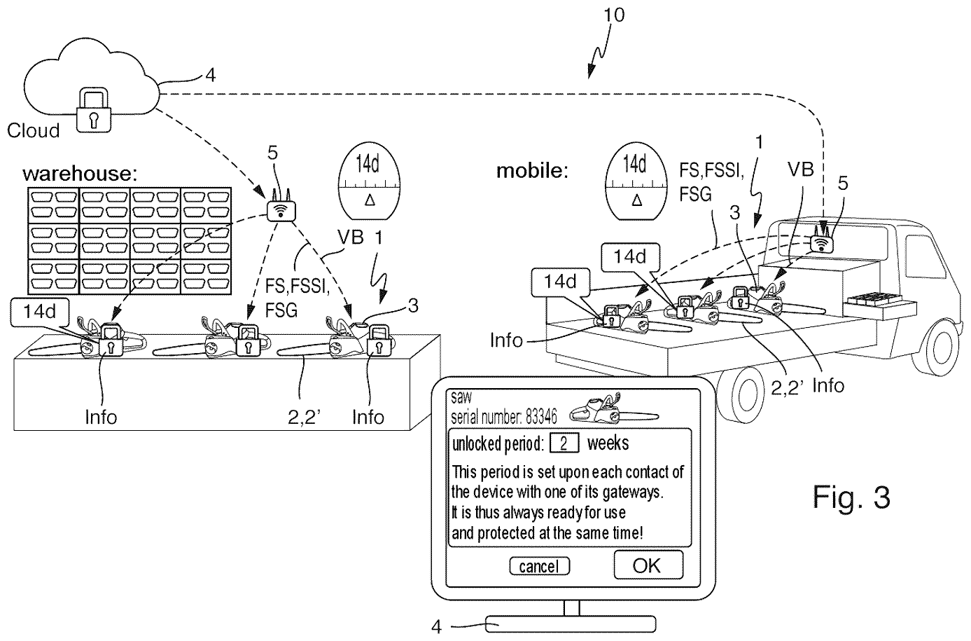

In particular, the mobile device 1 in the form of the motor-driven user-controlled, in particular manually-controlled, in particular handheld gardening, forestry, construction, and/or cultivating device 2 and/or the battery pack 3 for the gardening, forestry, construction, and/or cultivating device 2 for the method and/or the system 10 for unlocking the device 1 for the limited unlocked period of time, unlocked operating period of time, unlocked number of operating cycles, and/or unlocked amount of operating energy FS for operation of the device 1 outside the bounded position area bPB comprises the detecting unit 11 and/or the unlocking unit 12, as shown in FIG. 1 and also in FIGS. 2 and 3 for an alternative.

The detecting unit 11 is designed for detecting the device 1 inside the bounded position area bPB, in particular detects it. The unlocking unit 12 is triggered in that, if the device 1 is detected inside the position area bPB, it is designed for unlocking the device 1 for the limited unlocked period of time, unlocked operating period of time, unlocked number of operating cycles, and/or unlocked amount of operating energy FS for operation of the device 1 outside the bounded position area bPB, in particular unlocks it.

The computer program product comprises commands for unlocking the mobile device 1 in the form of the motor-driven user-controlled, in particular manually-controlled, in particular handheld gardening, forestry, construction, and/or cultivating device 2 and/or the battery pack 3 for the gardening, forestry, construction, and/or cultivating device 2 for the limited unlocked period of time, unlocked operating period of time, unlocked number of operating cycles, and/or unlocked amount of operating energy FS for operation of the device 1 outside the bounded position area bPB. The commands comprise:
upon execution, in particular by means of the detecting unit 11, detecting the device 1 inside the bounded position area bPB.
upon execution, in particular by means of the unlocking unit 12, triggered in that the device 1 is detected inside the position area bPB, unlocking the device 1 for the limited unlocked period of time, unlocked operating period of time, unlocked number of operating cycles, and/or unlocked amount of operating energy FS for operation of the device 1 outside the bounded position area bPB.

In detail, step a) comprises: determining a position PO of the device 1, in particular by means of the device 1 and/or a global positioning system gPBS, in particular a global navigation satellite system GNSS, and checking that the determined position PO is inside the position area bPB, as shown in FIG. 1.

Furthermore, the method comprises, chronologically before step a), the following step: receiving, in particular wirelessly receiving, at least one position area dimension bPBG representative of the position area bPB by means of the device 1, in particular from a first computing unit 4, as shown in FIG. 1. Additionally or alternatively determining a specified position vPO of the device 1 and receiving, in particular wirelessly receiving, a confirmation signal BSI for the confirmation of the determined specified position vPO to specify the position area bPB by means of the device 1, in particular from the first computing unit 4.

In addition, the method comprises, chronologically before step b), and in particular before step a), the following step: receiving, in particular wirelessly receiving, an unlocking dimension FSG representative of the unlocked period of time, unlocked operating period of time, unlocked number of operating cycles, and/or unlocked amount of operating energy FS for operation of the device 1 by means of the device 1, in particular from the first computing unit 4, as shown in FIG. 1 and also in FIGS. 2 and 3 for the one alternative. Furthermore, in FIG. 1, the reference sign AD designates an extension of the position area bPB.

Moreover, step a) and/or step b) is/are performed by means of the device 1, as shown in FIG. 1 and also in FIGS. 2 and 3 for the one alternative.

Furthermore, the position area bPB is bounded by a range RW of a connection VB that can be established for wireless reception between the device 1 and an assigned transmitting unit 5, as shown in FIGS. 2 and 3. Step a) comprises: detecting the device 1 inside the position area bPB by establishing the connection VB.

In detail, step a), in particular establishing the connection VB, comprises:
sending a device identifier 1ID from the device 1 and/or a unit identifier 5ID from the transmitting unit 5 and checking based on the sent device identifier 1ID, in particular in another alternative not the device 1, but rather the first computing unit 4 and/or the transmitting unit 5 comprise/comprises the detecting unit 11 and/or the unlocking unit 12 and/or step a) and/or step b) are/is not performed by means of the device 1, but rather by means of the first computing unit 4 and/or the transmitting unit 5, and/or the sent unit identifier 5ID, in particular in the one alternative the device 1 comprises the detecting unit 11 and/or the unlocking unit 12 and/or step a) and/or step b) are/is performed by means of the device 1, that the device 1 and the transmitting unit 5 are assigned to one another.

In addition, step b) comprises: sending an unlocking signal FSSI for unlocking the device 1 for the limited unlocked period of time, unlocked operating period of time, unlocked number of operating cycles, and/or unlocked amount of operating energy FS for the operation of the device 1, in particular the unlocking variable FSG representative of the unlocked period of time, unlocked operating period of time, unlocked number of operating cycles, and/or unlocked amount of operating energy FS for operation of the device 1, to the device 1 from the transmitting unit 5 through the connection VB, in particular in the other alternative not the device 1 but rather the first computing unit 4 and/or the transmitting unit 5 comprise/comprises the detecting unit 11 and/or the unlocking unit 12 and/or step a) and/or step b) are/is not performed by means of the device 1, but rather by means of the first computing unit 4 and/or the transmitting unit 5.

Furthermore, in FIG. 2 the reference sign ÜT designates a short-range transmission technology ÜT of sending and/or receiving, the reference sign BÜT designates a Bluetooth transmission technology of the transmission technology, the reference sign ZÜT designates a ZigBee transmission technology of the transmission technology, and the reference sign WÜT designates a wireless local area network transmission technology of the transmission technology.

In the exemplary embodiments shown, the transmitting unit 5 is a gateway 5′ and/or a router 5″. In alternative exemplary embodiments, the transmitting unit can be designed differently.

Moreover, in the exemplary embodiments shown the unlocked period of time, unlocked operating period of time, unlocked number of operating cycles, and/or unlocked amount of operating energy FS corresponds to 14 days (14 d) or 2 weeks. In alternative exemplary embodiments, the unlocked period of time, unlocked operating period of time, unlocked number of operating cycles, and/or unlocked amount of operating energy can be different.

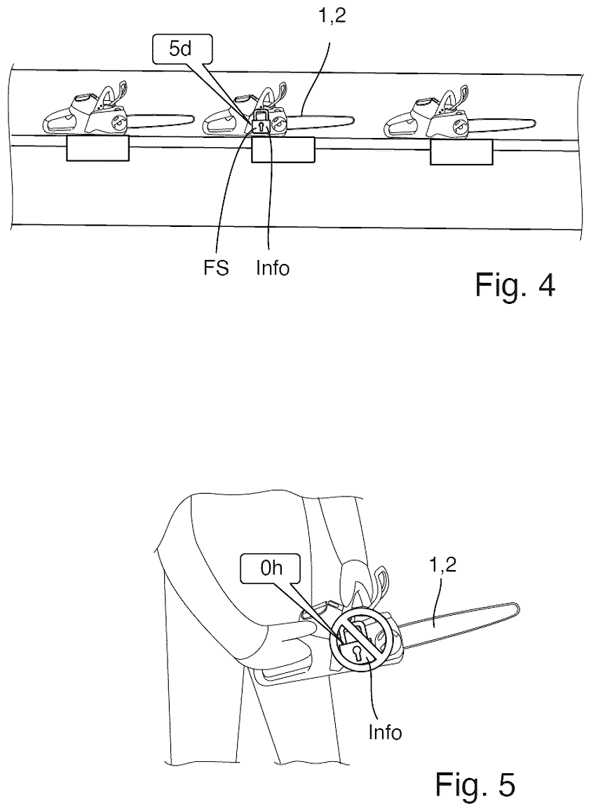

Furthermore, triggered by the unlocking of the device 1 for the limited unlocked period of time, unlocked operating period of time, unlocked number of operating cycles, and/or unlocked amount of operating energy FS, the unlocked period of time, unlocked operating period of time, unlocked number of operating cycles, and/or unlocked amount of operating energy FS counts down, as shown on the right in FIG. 1, and in FIG. 3 and FIG. 4, in particular outside the position area bPB and/or triggered in that the unlocked period of time, unlocked operating period of time, unlocked number of operating cycles, and/or unlocked amount of operating energy FS has expired, the operation of the device 1 is blocked, as shown on the left in FIG. 1 and in FIG. 5, in particular by means of the device 1.

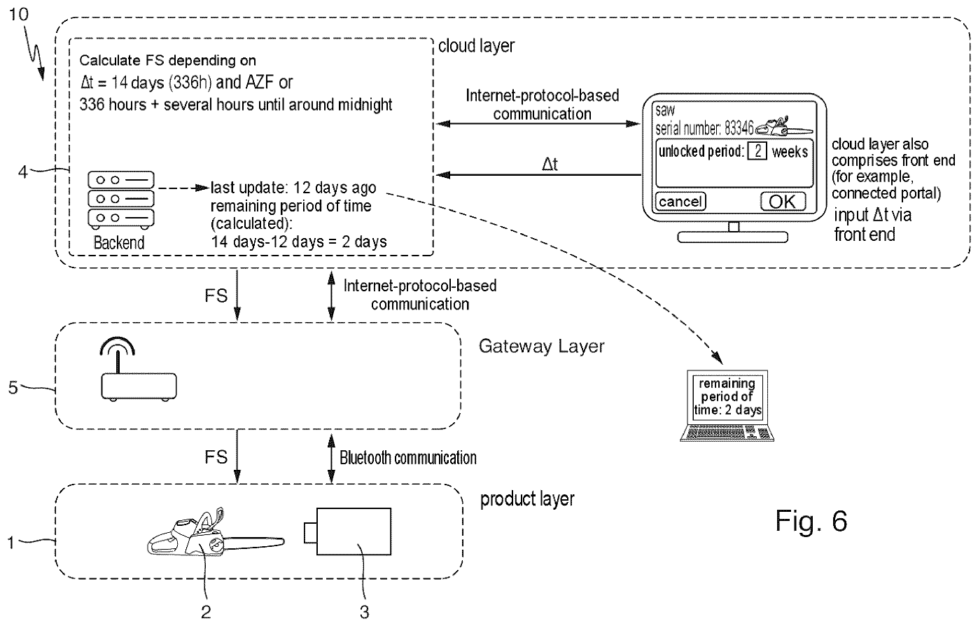

In detail, the method, in particular step b), comprises: determining and/or unlocking the unlocked period of time FS and/or blocking the operation of the device 1 such that the operation of the device 1 outside a defined working time window AZF is blocked for a use of the gardening, forestry, construction, and/or cultivating device 2 and/or the battery pack 3, as shown in FIG. 6.

In the exemplary embodiments shown, a local time zone of the device 1 for the blocking outside the working time window AZF and/or an additional time is introduced. In particular, the additional time lengthens the unlocked period of time FS such that the operation of the device 1 is blocked around midnight, for example, between 11 PM and 12 PM.

In addition, in the exemplary embodiments shown, an activation and/or a deactivation or a rights and roles concept for the protection is:
only the owner and/or the manager of the device 1 can activate or deactivate the protection for the device 1 by means of a front end;
a service-providing specialist store can view, for example, the remaining unlocked period of time by means of the front end. It can optionally set a limited unlocked period of time for service work;
the user can view the remaining unlocked period of time.

For status monitoring of the unlocked period of time by means of the front end (for example, in a connected portal), a presence of the device 1 may not be necessary (the device 1 does not have to communicate with the gateway for this purpose, for example, via Bluetooth).

The remaining unlocked period of time can be calculated, as shown in FIG. 6.

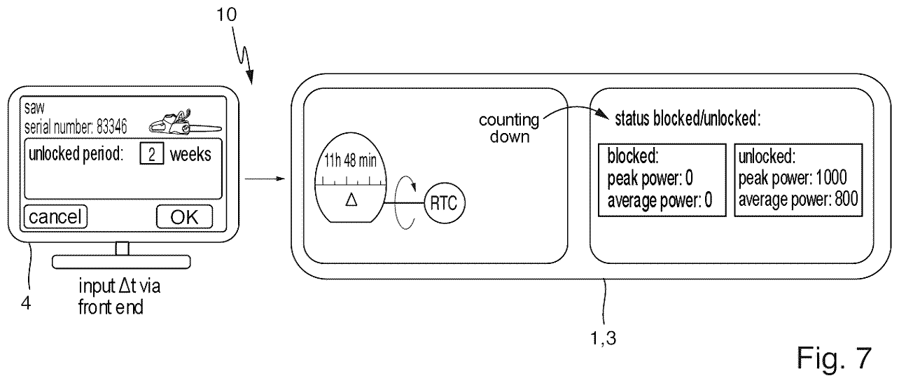

As shown in FIG. 7, the battery pack 3, in particular a battery management system BMS of the battery pack 3, can take the place of the gardening, forestry, construction, and/or cultivating device 2, in particular a motor electronics unit of the gardening, forestry, construction, and/or cultivating device 2. In particular, the blocking can always relate to discharging processes.

Furthermore, the method comprises: outputting, in particular optically outputting, user-perceptible information Info about whether or not the operation of the device 1 is unlocked FS for the unlocked period of time, unlocked period of operating time, unlocked number of operating cycles, and/or unlocked amount of operating energy, in particular that the unlocked period of time, unlocked period of operating time, unlocked number of operating cycles, and/or unlocked amount of operating energy FS is counting down, as shown in FIG. 1 on the right by a green color and in FIG. 4 by a flashing LED, or not, as shown on the left in FIG. 1 by a red color and in FIG. 5 by a continuously luminescent LED.

In the exemplary embodiments shown, the gardening, forestry, construction, and/or cultivating device 2 is a saw 2′. In alternative exemplary embodiments, the gardening, forestry, construction, and/or cultivating device can be designed differently.

As the exemplary embodiments shown and explained above make clear, the invention provides an advantageous method and an advantageous system for unlocking a mobile device, an advantageous mobile device for such a method and/or such a system, and an advantageous computer program product comprising commands for unlocking such a mobile device, which have/has improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for unlocking a mobile device, in the form of a motor-driven user-controlled handheld gardening, forestry, construction, and/or cultivating device and/or a battery pack for the gardening, forestry, construction, and/or cultivating device, for a limited unlocked period of time, unlocked operating period of time, unlocked number of operating cycles, and/or unlocked amount of operating energy for an operation of the mobile device outside a bounded position area, wherein the method comprises the steps of:
a) detecting whether the mobile device is inside the bounded position area; and
b) triggering, when the mobile device is detected inside the position area, an unlocking of the device for the limited unlocked period of time, unlocked period of operating time, unlocked number of operating cycles, and/or unlocked amount of operating energy, for the operation of the device outside the bounded position area.

2. The method according to claim 1, wherein step a) comprises:
determining a position of the mobile device; and
checking that the determined position is inside the bounded position area.

3. The method according to claim 1, wherein the method comprises, chronologically before step a), the step of:
receiving, by the mobile device, at least one position area dimension representative of the position area, and/or
determining a specified position of the mobile device and receiving, by the mobile device, a confirmation signal to confirm the determined specified position to specify the position area.

4. The method according to claim 1, wherein the method comprises, chronologically before step b), the step of:
receiving, by the mobile device, an unlocking variable representative of the unlocked period of time, unlocked operating period of time, unlocked number of operating cycles, and/or unlocked amount of operating energy for the operation of the device.

5. The method according to claim 1,
wherein the position area is bounded by a range of a connection that is enabled for wireless reception between the mobile device and an assigned transmitting unit, and
wherein step a) comprises: detecting the mobile device inside the position area by establishing the connection.

6. The method according to claim 5, wherein establishing the connection comprises:
sending a device identifier from the mobile device and/or a unit identifier from the transmitting unit, and checking based on the sent device identifier and/or the sent unit identifier that the mobile device and the transmitting unit are assigned to one another.

7. The method according to claim 5, wherein step b) comprises:
sending, to the mobile device, an unlocking signal to unlock the mobile device for the limited unlocked period of time, unlocked operating period of time, unlocked number of operating cycles, and/or unlocked amount of operating energy for the operation of the device.

8. The method according to claim 7, wherein
the unlocking signal is an unlocking dimension representative of the unlocked period of time, unlocked operating period of time, unlocked number of operating cycles, and/or unlocked amount of operating energy for the operation of the device.

9. The method according to claim 1,
wherein, triggered by the unlocking of the device for the limited unlocked period of time, unlocked operating period of time, unlocked number of operating cycles, and/or unlocked amount of operating energy, the unlocked period of time, unlocked operating period of time, unlocked number of operating cycles, and/or unlocked amount of operating energy, counts down, and/or
wherein, triggered when the unlocked period of time, unlocked operating period of time, unlocked number of operating cycles, and/or unlocked amount of operating energy has expired, the operation of the mobile device is blocked.

10. The method according to claim 9, wherein step b) comprises:
determining and/or unlocking the unlocked period of time and/or blocking the operation of the device such that the operation of the device outside a defined working time window is blocked for a use of the gardening, forestry, construction, and/or cultivating device and/or the battery pack.

11. The method according to claim 1, further comprising the step of:
outputting user-perceptible information about whether or not the operation of the device is unlocked for the unlocked period of time, unlocked operating period of time, unlocked number of operating cycles, and/or unlocked amount of operating energy.

12. The method according to claim 11,
wherein the user-perceptible information is about whether or not the unlocked period of time, unlocked operating period of time, unlocked number of operating cycles, and/or unlocked amount of operating energy is counting down.

13. A system for unlocking a mobile device, in the form of a motor-driven user-controlled handheld gardening, forestry, construction, and/or cultivating device and/or a battery pack for the gardening, forestry, construction, and/or cultivating device, for a limited unlocked period of time, unlocked operating period of time, unlocked number of operating cycles, and/or unlocked amount of operating energy, for an operation of the mobile device outside a bounded position area, the system comprising:
a detecting unit, which is designed for detecting the mobile device inside the bounded position area; and
an unlocking unit, which is triggered when the mobile device is detected inside the position area, designed to unlock the mobile device for the limited unlocked period of time, unlocked operating period of time, unlocked number of operating cycles, and/or unlocked amount of operating energy for the operation of the mobile device outside the bounded position area.

14. The system according to claim 13, wherein the system comprises the mobile device, which contains the detecting unit and/or the unlocking unit.

15. A mobile device in the form of a motor-driven user-controlled handheld gardening, forestry, construction, and/or cultivating device and/or a battery pack for the gardening, forestry, construction, and/or cultivating device, the mobile device comprising:
a detecting unit, which is designed for detecting the mobile device inside a bounded position area; and
an unlocking unit, which is triggered when the mobile device is detected inside the position area, designed to unlock the mobile device for a limited unlocked period of time, unlocked operating period of time, unlocked number of operating cycles, and/or unlocked amount of operating energy, for operation of the mobile device outside the bounded position area.

16. The method according to claim 1, wherein the method is carried out via commands stored on a non-transitory computer-readable medium of a computer product.
